(19) United States
(12) Patent Application Publication
(10) Pub. No.: US 2010/0033441 A1
(43) Pub. Date: Feb. 11, 2010

(54) APPARATUS AND METHOD FOR SENSING CONTINUAL TOUCH

(76) Inventors: Young-Un Park, Gyeonggi-do (KR); Deuk-Hoi Kim, Seoul (KR); Byeong-Geun Song, Gyeonggi-do (KR)

Correspondence Address: BIRCH STEWART KOLASCH & BIRCH, PO BOX 747, FALLS CHURCH, VA, 22040-0747, US

(21) Appl. No.: 12/521,727

(22) PCT Filed: Dec. 28, 2007
(86) PCT No.: PCT/KR2007/006942

§ 371 Date: Jun. 29, 2009

(30) Foreign Application Priority Data
Dec. 29, 2006 (KR) 10-2006-0138399

(51) Int. Cl. G06F 3/041

(52) U.S. Cl. 345/173

(57) ABSTRACT

A touch sensing apparatus and a method thereof that can recognize continual touch are disclosed. The touch sensing apparatus that is capable of recognizing continual touch, in accordance with an embodiment of the present invention can include: a first reference value, the first reference value being predetermined; and a second reference value, being configured to be between a first touch value and the first reference value, the first touch value satisfying the first reference value and outputting a touch recognition signal. The continual touch can be recognized by having the touch recognition signal output again in case the second reference value is satisfied. With the present invention, the key input can be still recognized even though the area or pressure of a finger is changed without removing the finger or the finger is momentarily removed and touched repeatedly.

### CROSS-REFERENCE TO RELATED APPLICATIONS

This application claims foreign priority benefits under 35 U.S.C. .sctn. 119(a)-(d) to PCT/KR2007/006942, filed Dec. 28, 2007, which is hereby incorporated by reference in its entirety.

### BACKGROUND

1. Technical Field

The present invention relates to an apparatus and method for sensing a contact by touch, more specifically to an apparatus and method for sensing a contact that is caused by continual touch.

2. Description of the Related Art

As input means for controlling the operation of electrical/electronic devices, touch input devices, such as touch sensors, which sense a contact by touch have been developed recently.

Fundamentally, a touch sensor is a device that recognizes the touch itself, and a touch input device is a device that senses the touch, outputs the sensed touch as a signal and uses the signal as input means. However, the two devices have been used indiscriminately.

While there are many ways to sense the touch, the most widely used method involves mounting an electrode at a contact part where the actual touch contact takes place, reading the change in capacitance when the contact part is touched by, for example, a finger, and transferring this signal to a microprocessor or microcomputer.

Over the conventional input methods of pressing mechanical buttons, this kind of conventional touch sensing method is easier to input and does not involve mechanical operations, eliminating the problem of mechanical wear. Accordingly, there have been wider areas of applications.

However, this kind of conventional touch sense method would not be able to correctly read the input if the pressure of the finger, which is placed on the contact part, was only changed without removing the finger or the finger touched the contact part very rapidly to repeat the input.

Consequently, the user would have to remove the finger from the contact part first and touch the contact part again in order to input a new entry.

Due to this kind of shortcoming, the touch sensor has not been widely used in an electrical/electronic device such as the remote control that required repeated inputs to change the channel or volume.

### SUMMARY

Contrived to solve the above problem, the present invention provides a touch sensing apparatus and method that can correctly read the continual touch even though the pressure of the finger, which is placed on the contact part, is only changed without removing the finger or the finger touches the contact part very rapidly to repeat the input.

The present invention also provides a touch sensing apparatus and method that does not require the user to move or remove the finger from the contact part first before touching the contact part again in order to have the input by continual touch correctly recognized.

The present invention also provides a touch sensing apparatus and method with the capability of correctly reading continual touch that can be widely used as input means in electronic/electrical devices.

Other problems that the present invention solves will become more apparent through the description of an embodiment of the present invention.

An aspect of the present invention features a touch sensing apparatus that is capable of recognizing continual touch.

The touch sensing apparatus, being capable of recognizing continual touch, in accordance with an embodiment of the present invention can include: a first reference value, the first reference value being predetermined; and a second reference value, being configured to be between a first touch value and the first reference value, the first touch value satisfying the first reference value and outputting a touch recognition signal. The continual touch can be recognized by having the touch recognition signal output again in case the second reference value is satisfied.

The second reference value can have a second touch value, satisfying the second reference value and outputting a touch recognition signal again. The second reference value can be configured to be between the second touch value and the first reference value if the second touch value and the first touch value are different.

The touch sensing apparatus can also include: capacitance, storing an electrical charge changing according to contact; a computing part, computing a change in capacitance stored in the capacitance; a first reference value setting part, storing the first reference value and determining whether the first reference value is satisfied by comparing a value computed by the computing part with eh first reference value; and a second reference value setting part, computing and storing the second reference value and determining whether the second reference value is satisfied by comparing a value computed by the computing part with the second reference value.

The computing unit can include: an RC oscillator, generating the change in capacitance according to the contact as a waveform; a clock generator, generating a digital signal from the waveform generated by the RC oscillator; and a counter, counting a clock value of the generated digital signal and indicating a capacitance value of the capacitance by using the counted clock value. The change in capacitance can be detected by using a change in the counted clock value.

Each of the first reference value setting part and the second reference value setting part can have a register, in which the first reference value and the second reference value are stored, respectively.

The capacitance value, which changes according to the contact, can be changed according to a change in at least one of the area and pressure of a part of a body being in contact.

Another aspect of the present invention features a method of touch sensing that is capable of recognizing continual touch.

According to an embodiment of the present invention, the method of touch sensing can include the steps of: (a) comparing a value according to a change in touch with a predetermined first reference value; (b) outputting a touch recognition signal if the first reference value is satisfied as a result of the comparison in the step (a), and configuring a second reference value to be between a first touch value and the first reference value, the first touch value allowing the touch recognition signal to output; (c) comparing a value caused by a change in touch with the second reference value; and (d) outputting a touch recognition signal again if the second reference value is satisfied as a result of the comparison in the step (c).

Another aspect of the present invention features a recorded medium having recorded a program for executing a method of touch sensing that is capable of recognizing continual touch.

According to an embodiment of the present invention, the recorded medium tangibly embodies a program of instructions executable by a digital processing apparatus to execute a method of touch sensing that is capable of recognizing continual touch. The program is readable by the digital processing apparatus and can execute the steps of: (a) comparing a value according to a change in touch with a predetermined first reference value; (b) outputting a touch recognition signal if the first reference value is satisfied as a result of the comparison in the step (a), and configuring a second reference value to be between a first touch value and the first reference value, the first touch value allowing the touch recognition signal to output; (c) comparing a value caused by a change in touch with the second reference value; and (d) outputting a touch recognition signal again if the second reference value is satisfied as a result of the comparison in the step (c).

In the step (b), if the first reference value is not satisfied as a result of the comparison in the step (a), the step (a) can be carried out again.

In the step (d), if the second reference value is not satisfied as a result of the comparison in the step (c), the step (a) can be carried out again.

If a second touch value, which satisfies the second reference value and allowing the touch recognition signal to output again, is different from the first touch value, the step (d) can also include a step of configuring the second reference value again such that the second reference value is between the second touch value and the first reference value.

In the step (a), the value according to a change in touch can be a capacitance value, which changes according to the touch. The capacitance value changing according to the touch can be generated by carrying out the steps of: generating a waveform from a change in capacitance according to the touch; generating a digital signal from the generated waveform; and counting a clock value of the generated digital signal.

### BRIEF DESCRIPTION OF THE DRAWINGS

FIG. 1 shows a block diagram of the structure of a touch sensor that is capable of recognizing continual touch in accordance with an embodiment of the present invention.

FIG. 2 shows a flowchart for setting a second reference value having a variable value that enables the recognition of continual touch in accordance with an embodiment of the present invention.

FIG. 3 shows a flowchart for a touch sensing method for recognizing continual touch in accordance with an embodiment of the present invention.

FIG. 4 shows waveform diagrams for comparing the touch sensing by a conventional touch sensing method with the touch sensing by a touch sensing method in accordance with an embodiment of the present invention, when identical touches are repeatedly inputted.

FIG. 5 shows waveform diagrams of an unchanged second reference value and a changed second reference value, based on the kind of continual touch, when the continual touch is inputted in a touch sensing method in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention.

Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

For instance, the first element can be named the second element, and vice versa, without departing the scope of claims of the present invention.

The term “and/or” shall include the combination of a plurality of listed items or any of the plurality of listed items.

When one element is described as being “connected” or “accessed” to another element, it shall be construed as being connected or accessed to the other element directly but also as possibly having another element in between.

On the other hand, if one element is described as being “directly connected” or “directly accessed” to another element, it shall be construed that there is no other element in between.

The terms used in the description are intended to describe certain embodiments only, and shall by no means restrict the present invention.

Unless clearly used otherwise, expressions in the singular number include a plural meaning. In the present description, an expression such as “comprising” or “consisting of is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains.

Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments will be described in detail with reference to the accompanying drawings. Identical or corresponding elements will be given the same reference numerals, regardless of the figure number, and any redundant description of the identical or corresponding elements will not be repeated.

The present invention first sets two reference values to have continual touch recognized, and one of the two reference values has a variable value.

For the convenience of description, one reference value, which is not variable, will be referred to as a first reference value, and the other reference value, which is variable, will be referred to as a second reference value, hereinafter.

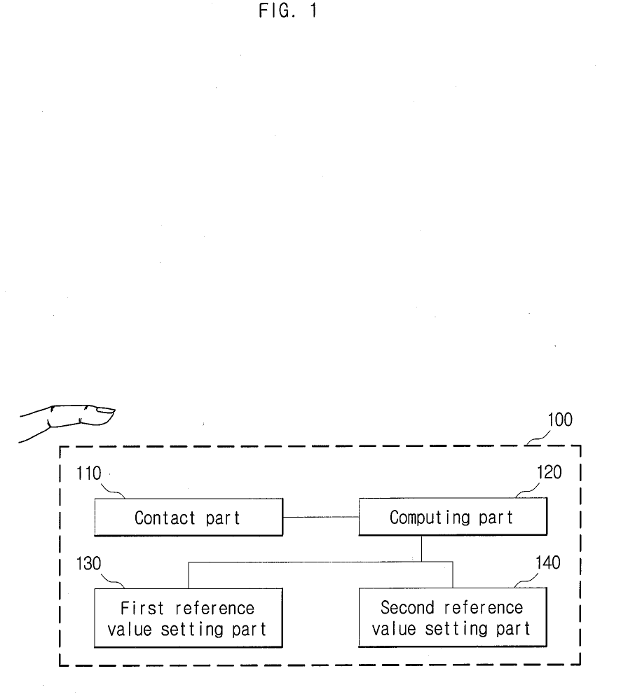

First of all, the structure of a touch sensor that can recognize continual touch in accordance with an embodiment of the present invention will be described with reference to FIG. 1.

FIG. 1 is a block diagram showing the structure of a touch sensor that can recognize continual touch in accordance with an embodiment of the present invention.

Referring to FIG. 1, the touch sensor 100 in accordance with an embodiment of the present invention can include a contact part 110, a computing part 120, a first reference value setting part 130, and a second reference value setting part 140.

The contact part 110 is the area with which a human finger, for example, makes contact and includes an electrode.

If there is a contact by touch on the contact part 110, a change in capacitance is caused by a minute change in current between the electrode and a person who is touching the contact part 110.

The capacitance can be changed by a variety of external factors, for example, the area of the finger making a contact with the contact part 110, the duration of contact, and the pressure of contact.

The computing part 120 converts the change in capacitance to a computable value and outputs the value.

For this, although not shown in FIG. 1, the computing part 120 can include an RC oscillator, a clock generator, and a counter.

The RC oscillator converts the change in capacitance caused by the contact to a waveform, and the clock generator converts the generated waveform to a digital signal.

The counter counts a clock value of the generated digital signal and indicates the change in capacitance through the difference in counted clock values. However, the functions of these elements are not limited to what is described herein.

The first reference value setting part 130 sets a first reference value for comparing with a value resulted from a first touch. The first reference value can be predetermined and prestored.

The first reference value is compared with a value resulted from a touch recognized by the first touch, and works as a reference to determine whether the touch shall be considered an actual touch.

For example, in the case of a touch pad, which is a common input device incorporating the touch sensor, the value resulted from a touch shall be greater than a predetermined reference value in order to avoid falsely considering a meaningless, light touch or a change in environment as an actual touch and outputting an unnecessary touch sensing signal.

As such, the first reference value prevents this kind of false operation caused by a light touch or a surrounding noise and determines whether a touch is a real touch for performing a particular operation. Only if the value from the touch is greater (and/or smaller) than the first reference value, the touch is considered an actual touch.

The second reference value setting part 140 generates a second reference value, according to a predetermined computing method, using the first reference value.

The second reference value setting unit 140 generates the second reference value only if the value for a recognized touch is greater (and/or smaller) than the first reference value.

For example, only when there is a first touch, which is enough to be recognized as a touch for generating an input signal, the second reference value is generated for recognizing a continual touch.

While the first reference value is for determining whether the touch is not a noise but a legitimate touch for performing a particular operation, the second reference value is between the first reference value and the first touch and thus is a variable value because the value caused by the first touch can be different each time.

If it is configured to recognize a value that is greater than the first reference value as an actual touch, the second reference value can be configured to be smaller than the value caused by the first touch and greater than the first reference value.

The second reference value can be computed by, for example, deducting a proportional value from the value caused by the first touch and taking this value as the second reference value, and having the second reference value generated between the first reference value and the value caused by the first touch.

After the first touch, whether a value generated by a second touch is an actual touch is determined with reference to the second reference value.

If there is a continual touch, the second reference value setting part 140 can set the second reference value differently in accordance with a value computed by the continual touch.

If it is configured to recognize the value greater than the first reference value as an actual touch, the greatest value computed and outputted by the computing part 120 will be the value caused by the first touch.

If, however, the value caused by the continual touch (“second touch”) after the first touch is greater than the value caused by the first touch, the second reference value is generated again with reference to the value caused by the second touch.

Although not shown in FIG. 1, the touch sensor in accordance with an embodiment of the present invention can include a register, in which the first reference value and the second reference value are stored.

In the structure of a touch sensor in accordance with an embodiment of the present invention, two reference values are used, unlike the conventional touch sensors, which use one reference value, and the second reference value can vary according to the first reference value and the value read by each touch of the continual touch.

Therefore, since the reference value changes according to the touch, the continual touch can be recognized, unlike the conventional method of recognizing the touch with one reference value only, in which the change in area or pressure of a finger is not recognized.

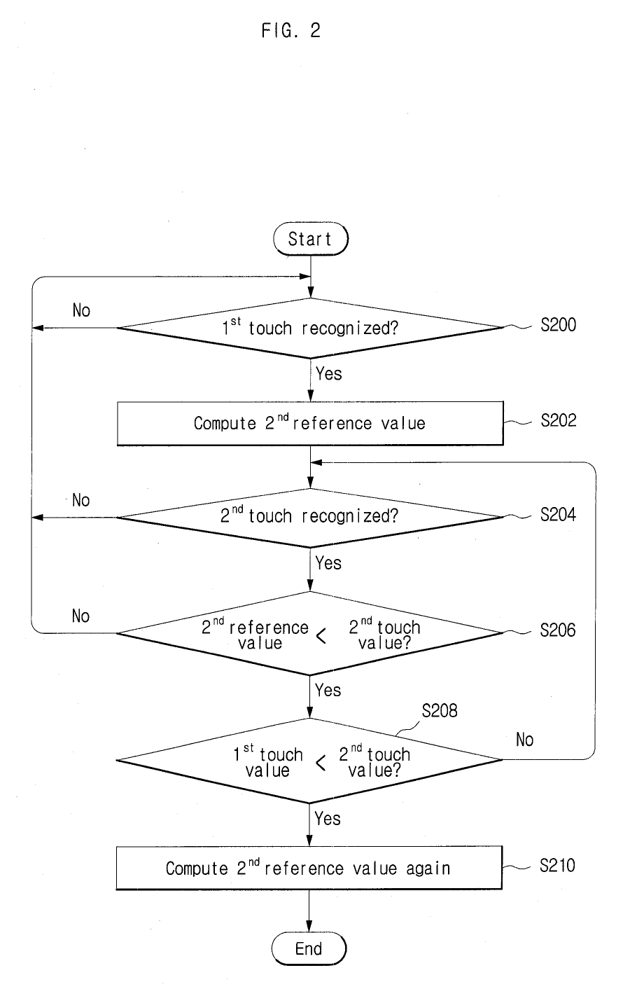

The steps of setting the second reference value, which varies to enable the recognition of such continual touch, will be described below with reference to FIG. 2.

FIG. 2 is a flowchart illustrating the steps of setting the second reference value, which has a variable value that enables the recognition of the continual touch, in accordance with an embodiment of the present invention.

As shown in FIG. 2, in order to set the second reference value in accordance with an embodiment of the present invention, it is first determined whether the first touch is recognized and outputted, in step S200. If the first touch is outputted, the second reference value is configured by computing the second reference value between the maximum value and the first reference value, in the step represented by S202.

There is no restriction on how the second reference value is computed as long as the second reference value is selected between the first touch value, which is the maximum value among the values caused by the first touch, and the first reference value, which is taken as the minimum value.

Once the second reference value is computed, it is determined in step S204 whether there is a touch (i.e. second touch) recognized due to a change in capacitance after the first touch, and the value caused by the second touch and the second reference value are compared in step S206.

In case the value caused by the second touch is smaller than the second reference value, the touch is not recognized at all, and the process returns to the state of waiting for a touch to be inputted.

If the compared value is greater than the second reference value, the touch is recognized and outputted, and the maximum value caused by the recognized touch is compared with the first touch value, which is the maximum value caused by the first touch, in step S208.

In case the compared value is smaller than the first touch value, the second reference is not computed or configured again, but the process returns to recognize the second touch, which is caused by a change in capacitance.

If, however, the second touch value is greater than the first touch value, the second reference value is re-computed based on the second touch value, and the changed value is configured as the second reference value, in step S210.

Although FIG. 2 shows the re-configuration of the second reference value after the initial configuration when the second touch value is greater than the first touch value, it is possible to re-configure the second reference value after the initial configuration in a variety of methods.

For example, it is possible to have the second reference value re-configured if the first touch value and the second touch value are different, but the possibilities shall not be limited to what is described herein.

According to the configuration of the variable second reference value, whether a legitimate touch has occurred is determined by comparing the values caused by the change in capacitance based on the second reference value after the first touch is made.

Moreover, as the second reference value changes according to the first reference value and the value recognized by a touch, any change in capacitance, caused by, for example, changing the finger pressure on the contact part without removing the finger or changing the area of the finger that is in contact with the contact part, can be also recognized.

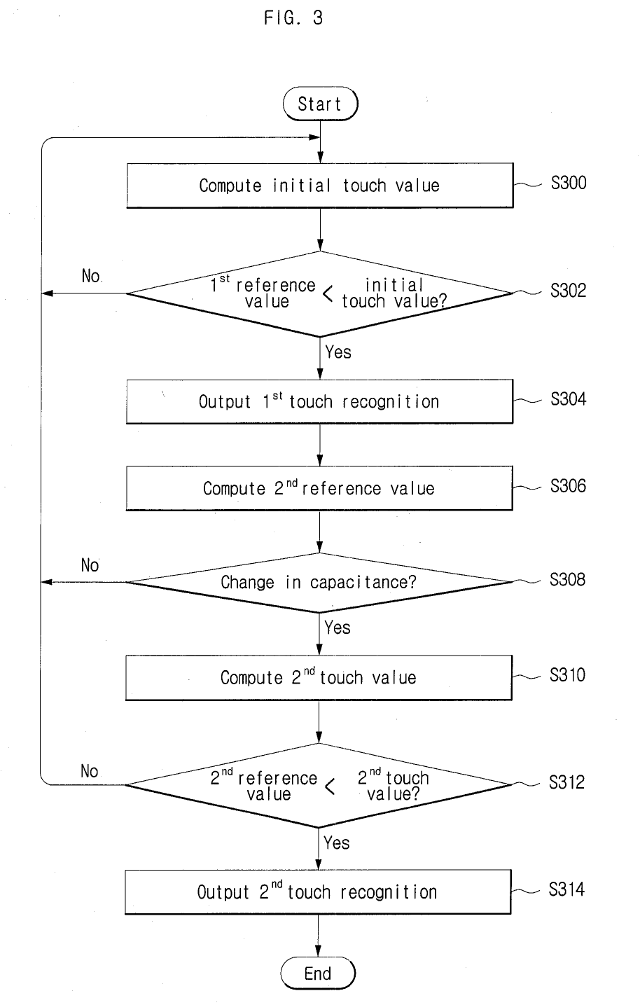

Hereinafter, the method of recognizing a continual touch in accordance with an embodiment of the present invention will be described with reference to FIG. 3.

FIG. 3 is a flowchart showing a touch sensing method for recognizing continual touch in accordance with an embodiment of the present invention.

FIG. 3 illustrates a case of recognizing a touch as an actual touch if the computed value is greater than a predetermined reference value.

In order to recognize continual touch in accordance with an embodiment of the present invention, an initial touch on the touch sensor of a user is detected, and the detected touch is computed to be expressed as a value, in the step represented by S300.

Then, the computed value, which is referred to as an initial touch value, is compared with the first reference value in step S 302.

If the initial touch value is determined to be greater than the first reference value, the initial touch is recognized as a first touch, and a touch recognition signal is outputted in S304, and computation is made to configure a second reference value in S306.

If the initial touch value is smaller than the first reference value, the touch is determined to be caused by a false operation, referred to as a noise, and no operation is made and the process waits until another touch is recognized.

As described above, the maximum value among values caused by touch recognized as the first touch becomes the maximum value for the configuration of the second reference value, and this value can be set greater than the first reference value.

As described above also, there is no restriction on how the second reference value is computed as long as the second reference value is selected between the maximum value of the second reference value, which is the maximum value among the values caused by the first touch, and the first reference value, which is taken as the minimum value.

Once the second reference value is configured, it is determined whether there is any change in value caused by a change in capacitance in step S308, and the value computed by the change in touch is compared with the second reference value in step S312.

In step S314, if the value computed by the change in touch is greater than the second reference value, the changed value is recognized as the second touch, and a touch recognition signal is outputted again. If the value computed by the changed touch is not greater than the second reference value, it is determined that the touch is caused by a false operation, and no operation is made and the process returns to the initial step.

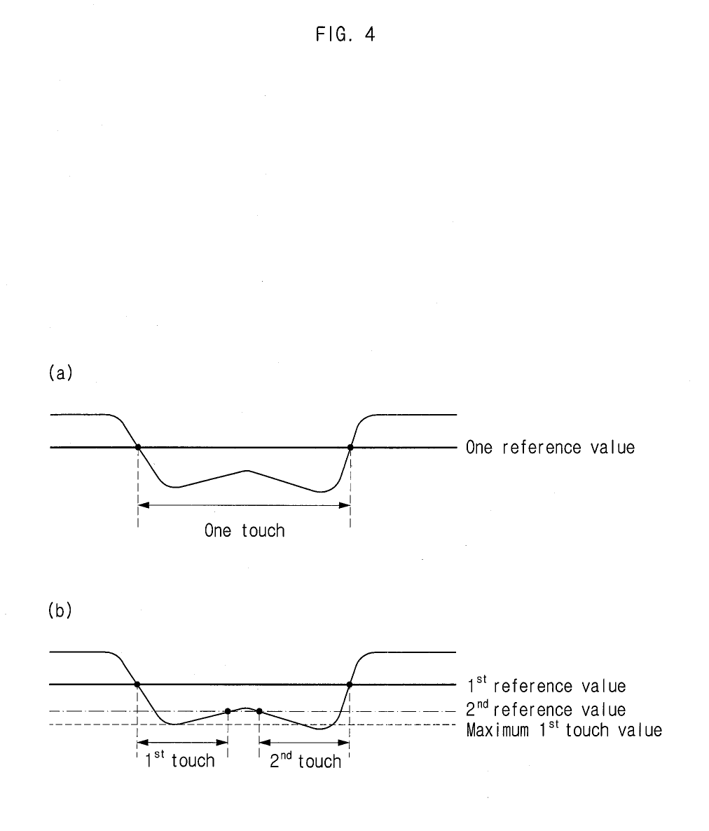

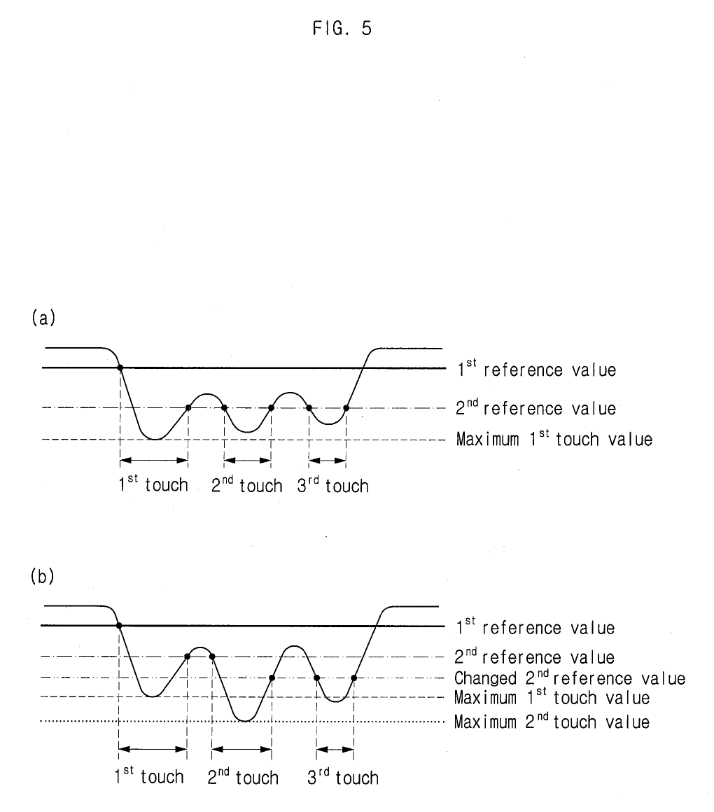

The above process of recognizing continual touch is described below by referring to waveforms illustrated in FIGS. 4 and 5.

FIG. 4 is a waveform for comparing a conventional touch sensing method and the touch sensing method in accordance with an embodiment of the present invention, when identical continual touch is inputted.

Referring to FIG. 4, in which identical touch in continually inputted, diagram (a) is a case of the conventional touch sensing method, and diagram (b) is a case of the touch sensing method in accordance with an embodiment of the present invention.

In the conventional touch sensing method, as shown in diagram (a) of FIG. 4, only one touch is recognized even though the touch is continually inputted without removing the finger from the contact part, because only one reference value is used.

Moreover, in the conventional method, if the waveform shown in diagram (a) of FIG. 4 continues, the touch is recognized as an actual touch, not a noise, for a predetermined period only, in order to prevent the same touch being recognized too long.

Therefore, in the conventional method, if the user continuously touches the contact part by changing the area or pressure of the finger without removing the finger, this touch is recognized as the same one touch or as a noise.

However, the touch sensing method in accordance with an embodiment of the present invention, as shown in diagram (b) of FIG. 4 sets not only the first reference value but also the second reference value based on the first reference value and the maximum value caused by the first touch. Thus, one touch is recognized by the first reference value, and another touch is recognized by the second reference value.

Besides, as described above, the second reference value is changed according to continual touch.

FIG. 5 is waveforms of a case of the second reference value changing and another case of the second reference value not changing, when the touch is continually inputted in the touch sensing method in accordance with an embodiment of the present invention.

Diagram (a) of FIG. 5 illustrates a waveform in which the second reference value is not changed based on the kind of continual touch when the touch is inputted continuously.

As shown in diagram (a) of FIG. 5, the second reference does not change if the maximum value caused by the second touch is not greater than the maximum value caused by the first touch.

If, however, the maximum value caused by the second touch is greater than the maximum value caused by the first touch, as shown in diagram (b) of FIG. 5, the second reference value is changed based on the maximum value caused by the second touch.

By allowing the second reference value to change in accordance with the first reference value, which is for determining whether the touch is made, and the maximum values, which are generated by continual touch, the continual touch can be recognized although the user changes the area or pressure of the finger without removing the finger from the contact part of the touch sensor.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

As described hitherto, the touch sensor and method thereof that is capable of recognizing continual touch in accordance with the present invention can recognize the touch even though the user changes the pressure of the finger without removing the finger or rapidly repeats the touch.

Furthermore, the touch sensor and method thereof that is capable of recognizing continual touch in accordance with the present invention can be widely used as input means for an electrical/electronic device that requires successive inputs.

What is claimed is:

1. A touch sensing apparatus, being capable of recognizing continual touch, the device comprising:
a first reference value, the first reference value being predetermined; and
a second reference value, being configured to be between a first touch value and the first reference value, the first touch value satisfying the first reference value and outputting a touch recognition signal,
wherein the continual touch is recognized by having the touch recognition signal output again in case the second reference value is satisfied.

2. The apparatus of claim 1, wherein the second reference value is a value in which a proportional value is deducted from the first touch value.

3. The apparatus of claim 1, wherein the second reference value comprises a second touch value, satisfying the second reference value and outputting a touch recognition signal again, wherein the second reference value is configured to be between the second touch value and the first reference value if the second touch value and the first touch value are different.

4. The apparatus of claim 1 further comprising:
capacitance, storing an electrical charge changing according to contact;
a computing part, computing a change in capacitance stored in the capacitance;
a first reference value setting part, storing the first reference value and determining whether the first reference value is satisfied by comparing a value computed by the computing part with eh first reference value; and
a second reference value setting part, computing and storing the second reference value and determining whether the second reference value is satisfied by comparing a value computed by the computing part with the second reference value.

5. The apparatus of claim 4, wherein the computing unit comprises:
an RC oscillator, generating the change in capacitance according to the contact as a waveform;
a clock generator, generating a digital signal from the waveform generated by the RC oscillator; and
a counter, counting a clock value of the generated digital signal and indicating a capacitance value of the capacitance by using the counted clock value,
wherein the change in capacitance is detected by using a change in the counted clock value,
wherein, if the process is computing data, the command processing information comprises type information for designating the type of the process, a plurality of address information of where source data is written in the storage area, and address information of where data computed from the source data is to be written.

6. The apparatus of claim 4, wherein each of the first reference value setting part and the second reference value setting part comprises a register, in which the first reference value and the second reference value are stored, respectively.

7. The apparatus of claim 4, wherein the capacitance value, which changes according to the contact, is changed according to a change in at least one of the area and pressure of a part of a body being in contact.

8. A method of touch sensing, being capable of recognizing continual touch, the method comprising:
(a) comparing a value according to a change in touch with a predetermined first reference value;
(b) outputting a touch recognition signal if the first reference value is satisfied as a result of the comparison in the step (a), and configuring a second reference value to be between a first touch value and the first reference value, the first touch value allowing the touch recognition signal to output;
(c) comparing a value caused by a change in touch with the second reference value; and
(d) outputting a touch recognition signal again if the second reference value is satisfied as a result of the comparison in the step (c).

9. The method of claim 8, wherein, in the step (b), if the first reference value is not satisfied as a result of the comparison in the step (a), the step (a) is carried out again.

10. The method of claim 8, wherein, in the step (d), if the second reference value is not satisfied as a result of the comparison in the step (c), the step (a) is carried out again.

11. The method of claim 8, wherein, if a second touch value, which satisfies the second reference value and allowing the touch recognition signal to output again, is different from the first touch value, the step (d) further comprises a step of configuring the second reference value again such that the second reference value is between the second touch value and the first reference value.

12. The method of claim 8, wherein, in the step (a), the value according to a change in touch is a capacitance value, which changes according to the touch.

13. The method of claim 12, wherein the capacitance value changing according to the touch is generated by carrying out the steps of:
generating a waveform from a change in capacitance according to the touch;
generating a digital signal from the generated waveform; and
counting a clock value of the generated digital signal.

14. A recorded medium tangibly embodying a program of instructions executable by a digital processing apparatus to execute a method of touch sensing that is capable of recognizing continual touch, the program being readable by the digital processing apparatus, the program executing:
(a) comparing a value according to a change in touch with a predetermined first reference value;
(b) outputting a touch recognition signal if the first reference value is satisfied as a result of the comparison in the step (a), and configuring a second reference value to be between a first touch value and the first reference value, the first touch value allowing the touch recognition signal to output;
(c) comparing a value caused by a change in touch with the second reference value; and
(d) outputting a touch recognition signal again if the second reference value is satisfied as a result of the comparison in the step (c).

15. The recorded medium of claim 14, wherein, in the step (b), if the first reference value is not satisfied as a result of the comparison in the step (a), the step (a) is carried out again.

16. The recorded medium of claim 14, wherein, in the step (d), if the second reference value is not satisfied as a result of the comparison in the step (c), the step (a) is carried out again.

17. The recorded medium of claim 14, wherein, if a second touch value, which satisfies the second reference value and allowing the touch recognition signal to output again, is different from the first touch value, the step (d) further comprises a step of configuring the second reference value again such that the second reference value is between the second touch value and the first reference value.
